(19) United States
(12) Patent Application Publication
(10) Pub. No.: US 2016/0153511 A1
(43) Pub. Date: Jun. 2, 2016

(54) IMPROVEMENTS TO STRUCTURE TO RESIST IMPACT

(71) Applicants: Simon DICKINSON, Scarborough, North Yorkshire (GB); Amber Lee DICKINSON, Scarborough, North Yorkshire (GB)

(72) Inventors: Simon Dickinson, Scarborough, North Yorkshire (GB); Amber Lee Dickinson, Scarborough, North Yorkshire (GB)

(21) Appl. No.: 14/903,393

(22) PCT Filed: Jul. 9, 2014
(86) PCT No.: PCT/GB2014/052089

§ 371 Date: Jan. 7, 2016

(30) Foreign Application Priority Data
Jul. 9, 2013 (GB) 1312305.4
Jun. 16, 2014 (GB) 1410687.6

(51) Int. Cl. F16F 5/00; B60N 2/70

(52) U.S. Cl. CPC F16F 5/00; B60N 2/7082

(57) ABSTRACT

The invention relates to the provision of a structure (2) which can be used alone or in conjunction with other components, such as a support frame or the like. The structure is movable to a condition for use, at the time of manufacture or subsequently, in which the interior of a number of cells in the structure are filled with a fluid, most typically by inflation with a gas such as air. The structure includes a plurality of cells (14) which can be filled with air, and at least two of which are interconnected to allow the flow of fluid therebetween during use and particular upon impact on one of cells occurring, so as to mitigate the effect of the impact in a controlled manner.

The invention to which this application relates are improvements and further features relating to a structure which can be filled with a fluid such as a gas or liquid and is provided to allow comfort and support, and particularly allow resistance to be provided to the user from the potentially damaging effect of impact on the structure. The structure may, although not necessarily exclusively, be provided in the form of a seat, a deck, walls or ceilings or any combination of the same. In one embodiment the structure can be used to allow the person to be protected from the effect of impact on the structure directly, or on the vehicle, whether it be a seagoing vessel such as a ship, plane or land based vehicle such as a car or military vehicle, or other apparatus in relation to which the structure is in use and/or allow the form of the structure to be adapted but maintained in a protective manner use. In one embodiment the impact may be caused by a collision or, alternatively as a result of an explosive blast in the vicinity of the apparatus.

Conventionally, when a designer is designing a structure to reduce the effect of impact, they will choose a shape that most suits the needs of the application; they will then choose a grade of suitable material throughout, such as foam, which most suits the needs of the comfort necessary and dynamic performance required. Once the material has been chosen, it becomes a static part of the structure that cannot be changed. When the material part of the structure is, for example, sat upon, the weight of the occupant squashes the structure, so reducing its mass and cushioning properties. This reduction in mass equates to a reduction in its comfort and impact absorbency. Other conventional forms of apparatus includes suspension seating that incorporates mechanical means to attempt to reduce the shock upon impact.

A problem which is experienced in inflatable structures is that when the same are the subject of an impact, the same can have a tendency to deform in such a manner that the safety characteristics of the same are lost and/or the person using the structure at that time may not be properly protected from the effects of the impact. This can lead to inflatable structures failing to meet the required safety standard tests. A further problem is that when a person is sitting on the structure and moves around, the pressure of air in the cells of the structure can change and provide unsatisfactory comfort and/or safety. Another problem with conventional inflatable structures is that the application of an impact can cause a trampoline effect to be created in the structure and in which fluid which is initially displaced from the area of impact then “rebounds” or returns to the area of impact and, in certain scenarios, can force the person away from the structure and into potentially hazardous situations.

The applicant, in their co-pending application WO2009/004353 describes the provision of a seat which can be inflated to a condition for use. In that application there is described the provision of a series of cells which, when inflated, form the seat into the required shape.

The aim of the present invention is to provide improvements to a structure design which allow the structure to have improved characteristics with respect to the ability to absorb the effects of sudden impact, with the aim being to minimise the effect of the impact on the structure and also to minimise the effect of the impact on the person using the structure. A further aim is to improve the movement of the filling fluid through the structure in a controlled manner.

In a first aspect of the invention there is provided a fluid filled structure, said structure having a body with a plurality of portions, said portions formed from a plurality of cells in which the fluid is received and wherein at least two of said cells are interconnected by at least one port to allow the passage of fluid between said cells in order to allow the transfer of the fluid between the cells once the structure is filled with the desired quantity of the fluid for use and during use of the structure.

In one embodiment a first cell is provided with a top wall and a base wall spaced apart by side walls, said side walls attached to, or common with, side walls of one or more adjacent cells such that the said first cell is substantially surrounded by one or more cells to the side thereof.

In one embodiment the said first cell is located in the structure at a location where it is predicted or known that there is the greatest likelihood of impact occurring.

In one embodiment the said first cell is provided in fluid communication with the cell or cells adjacent the side walls thereof via the one or more ports in order to allow the passage of fluid between the respective cells.

In one embodiment there are provided one or a series of cells in successive phases around said first cell, and each cell or cells phase in interconnected with one or both phases of cell or cells adjacent thereto via said ports.

In one embodiment the passage area of the port or ports in combination which connect the first cell to the surrounding cell or cells phase and through which fluid can pass is greater than the passage area of the port or ports in combination which connect the surrounding cell or cells phase to the next phase of cell or cells.

In one embodiment the passage area of the port or ports in combination which connect the first cell to the surrounding cell or cells phase and through which fluid can pass is less than the passage area of the port or ports in combination which connect the surrounding cell or cells phase to the next phase of cell or cells.

In one embodiment when the structure is in a dormant state no, or limited movement of fluid occurs. Typically a sudden impact and/or movement of a person in contact with the apparatus will cause the fluid to move between the said cells and thereby allow the effect of the impact and/or movement to be mitigated. Typically the movement of the fluid is achieved in a regulated manner by the appropriate dimensioning of the one or more ports which interconnect the cells.

In one embodiment the diameter, or longest length of the ports are in the range of 2-15 mm. In one embodiment the size of the ports within a particular structure are varied to allow the controlled movement of the fluid through different parts of the structure.

In one embodiment the structure is a seat having a base and/or cushion and, optionally, a back portion may be provided in conjunction with the base. It should be appreciated that the whole of the seat need not be formed by the structure in accordance with the invention. For example, in one embodiment the seat may comprise a frame which is used to support the inflatable structure in accordance with the invention. Alternatively at least one of the portions of the seat, such as the base or back portion, can be formed in a conventional manner from foam or another suitable material, with the other of the portions formed by the structure in accordance with the invention.

In one embodiment there is provided a structure which is composite in form with a portion of the same formed by foam or another suitable material and a further portion formed by a structure in accordance with the invention.

Typically the fluid is a gas such as air which is used to inflate the structure. However other fluids may be used, such as oil, gel or other liquids. Reference is made to the use of air hereon in but in a non-limiting manner.

In one embodiment the size of the at least one port is selected with respect to the desired volume of air which is to be allowed to pass through the same at a given time period and/or upon a specific event occurring.

In one embodiment the specific event is a sudden impact on the structure or on the body to which the structure is connected.

Typically the port is of a dimension and/or is controlled such as to restrict the passage of air so as to maintain the structure in a desired form and/or maintain the air pressure within a specific cell or cells when the pressure on that cell is increased so as to slow down the change in the structure and size of the cell for at least a period of time following the occurrence of the event which caused the increase in pressure.

In one embodiment the structure is formed by a plurality of cells which are interconnected and in one embodiment adjacent cells are interconnected by at least one port and arranged in series.

In another embodiment a first cell is at least partially surrounded by an adjacent cell and interconnected to the same via at least one port. In one embodiment this arrangement is repeated for successive cells.

In one embodiment, when a series of cells are interconnected, the size or control of the at least one port which allows connection between adjacent cells is selected with respect to each cell such that the parameters for a port between first and second interconnected cells may differ to those for the at least one port between second and third cells and so on. This allows a controlled air flow to be achieved through the structure and for the specific air flow which is required at specific locations of the structure to be achieved in order, most typically, to disperse the air away from the area of impact but to do so in a controlled manner in order to allow the air to still provide support at the are of impact for the person in contact therewith.

In one embodiment the interconnected cells which are closest to a predetermined most likely point of impact on the structure when in use are interconnected by one or more ports which are of a dimension so as to allow a greater flow of air therethrough in comparison to the port or ports which interconnect other cells of the structure which are further removed from the predetermined point of impact.

In one embodiment the flow of the fluid between the interconnected cells is controlled by the selective dimensioning of the ports in the walls which define the cells.

In one embodiment, in addition to the ports, control means can be provided to control the flow of air in terms of volume and/or direction such that, for example, a larger volume of air is allowed to flow in one direction through the port than in the opposing direction.

In one embodiment the port is of a shape and dimension to suit the specific air flow characteristics at that location within the seat.

Typically the ports act as a choking system for the movement of air through the seat whilst allowing an allowable quantity of air therethrough.

In one embodiment the port is formed with a restriction formation which is changeable in response to the fluid pressure in the adjacent cells at that given time. Typically the restriction formation is such as to allow greater flow of air between adjacent cells when the pressure is greater and restricts the movement of air back to the cell from which it came to thereby provide an equalising effect. This is all provided in a manner to prevent the unrestricted movement of air and in particular to prevent the unrestricted movement of air returning to the area of impact and so, in turn, prevent the trampolining effect being created within the structure.

In one embodiment the size of the respective cells in the structure can be varied to offer differing compression characteristics at differing locations on the structure.

In one embodiment the structure includes at least one pump for the movement of fluid into the structure and, typically one or more regulators to allow the controlled movement of the fluid. The addition of the pump and regulators allows the structure to become reactive to any, or any combination of, comfort, driver weight adjustment, and/or alternating pressure in different cells. Alternatively, the structure cells may be filled with the fluid at the time of manufacture and thereafter retained in that condition during subsequent use.

In one embodiment a compressible material, such as foam, is provided within the structure to form at least part of the structure. This can be provided such that if one or more cells of the structure were to burst then the person can still be provided with at least some degree of comfort by sitting on foam.

Typically the cells are defined by a top face and an opposing, spaced, bottom face and the side walls of the cell are defined by I beams connecting the top and bottom faces.

In one embodiment the base of the structure is formed from a plurality of interconnected cells and at least the cell or cells which are located at the part of the base onto which a person normally sits, and which therefore normally have the greatest pressure thereon, are interconnected to adjacent cells via one or more ports which are relatively small in size, and/or are controlled such that the passage of air to adjacent cells is relatively slow, thereby allowing the maintenance of the air pressure in the cells which are most often subject to the pressure of the person sitting on the same.

In one embodiment the structure includes side wall portions formed of one or more cells and said cells may be interconnected to each other and/or interconnected to cells in other parts of the structure via one or more ports.

In one embodiment the material from which the cells are formed has a degree of elasticity which is also taken into account when selecting the dimensions of the ports.

Typically the structure can be inflated/deflated via a single valve opening or, alternatively, via multiple inlets for the fluid to different sections or units of the structure so as to allow the independent control of the pressure in each cell or section or unit, in one embodiment, via a pump and control means.

In one embodiment the body is located within a flexible outer envelope which forms the external surface of the structure.

In one embodiment the body is secured to a relatively rigid support which forms a rear support shell to the structure. In one embodiment the body is selectively locatable with the support shell.

In one embodiment the structure body is provided as part of a seat or deck such that the same is used in conjunction with one or more further fixed, formed, seat or deck parts, to form the overall seat for use.

In one embodiment the structure is provided with an inflatable and/or compressible material, such as foam, and/or solid bolster which can be positioned in front of the structure and in front of the person sat on the structure. Typically the bolster can be attached to the structure and the bolster may be self inflating, rigid or fully inflatable.

In one embodiment the structure is provided with securing and/or locating portions for one or more restraint belts so as to allow the person to be safely secured in position on the seat. In one embodiment the securing and/or locating portion is provided in the form of a channel which passes between the front and rear walls of the structure body.

In one embodiment the structure includes a further inflatable cell or vent bag which is connected to, but separate from, the structure, said further inflatable cell or vent bag acting as a reservoir for a quantity of air and which is connected to allow the transfer of air between the further inflatable cell or vent bag and at least one of the cells of the structure to allow a breathing effect to be achieved.

In one embodiment the further inflatable cell or vent bag is provided to allow a quantity of fluid to be available to be moved between the structure and further inflatable cell or vent bag upon impact. In one embodiment the further inflatable cell or vent bag is located as part of the apparatus in which the structure in accordance with the invention is provided.

Typically the inflatable cell or vent bag acts as a reservoir into or from which air can pass during use of the structure and is of particular use in relation to relatively large impacts and/or in relatively small structures in which the available space for the air to move to during use is relatively restricted. The provision of the inflatable cell or vent bag connected to, but provided separately from, the structure means that the vent bag can be stored separately and be available to receive air and/or provide the same as and when required.

In a further aspect of the invention there is provided an inflatable structure, said structure including a body formed from a plurality of inflatable cells wherein at least first and second cells are interconnected to allow air flow between the same via one or more ports formed in a side wall common to adjacent cells.

In one embodiment further cells are interconnected in the same way and the dimension of at least one of said ports between adjacent cells differs to those of the other ports which are provided.

In one embodiment the structure has the ability to be adjusted to suit the driving conditions at this time.

In one embodiment, for off road driving the structure can provide vertical shock absorbency and lateral support in which the structure base reacts as a suspension structure and the back and lateral portions of the structure offer greater support, so increasing driver comfort and protection.

In another mode a firmer structure base is provided, giving a sportier feel to the driver and a better feel of the road, whilst offering excellent levels of safety and comfort.

In one embodiment, for longer distance driving in which a driver will spend a prolonged time at the wheel and which can cause such things as driver fatigue, numbness in the legs and lower back and reduced pulmonary blood flow, the structure is provided to spread the weight of the occupant efficiently over the base, and more efficiently than foam seats, so reducing these negative effects and increase driver comfort. In one embodiment the structure can be connected to heater or air conditioning system to allow the temperature control of the fluid within the structure.

In one aspect of the invention the inflatable structure is used to form a surface of, for example, any or any combination of a wall, floor, or ceiling to act as a shock absorbent means for blasts, the surface or deck of a vessel such as a racing boat, or as packaging means such as a carrying or transport casing for goods.

In one embodiment the structure includes any or any combination of pumps, air regulators and pipes or tubes to allow the inflation and control of pressure in various portions and cells of the structure to allow the structure and portions thereof to be adapted for use.

In one embodiment the structure in accordance with the invention can have many uses such as use as a seat in any or any combination of vehicles, marine craft, aircraft, military vehicles, use by children with special needs, decks or floors, Wall liners, Sports clothing protective equipment, military, police protective equipment, child seats, helmet liners, office chairs, soft play environments, sledges, soles of shoes, gym mats and/or saddles for horses.

In a further aspect of the invention there is provided a structure which is provided as a means of mitigating the effect of an impact or blast on a person in contact with or in the vicinity of the said structure and wherein said structure includes a plurality of cells, each of cells provided to be moved and/or retained in an inflated condition by a pressurised gas contained therein and wherein at least two of the said cells are interconnected such that when inflated, the fluid can pass between the said interconnected cells in a regulated manner.

Typically the regulation is achieved by the provision of one or more ports or passages which interconnect the said cells so as to allow the passage of gas between the cells but to restrain the speed of transfer of gas between the ports or passages.

In one embodiment the structure is provided with a first surface onto which a person is able to place part of their anatomy, such as their feet, and the opposing surface of the structure is provided to face towards the most likely source of the impact such that the structure is positioned intermediate the person's anatomy and the source of impact.

In one embodiment the structure includes a frame which defines an aperture in which the plurality of inflated cells are located.

In a further aspect of the invention the structure is provided in the form of a chair and said chair having a base and a back rest and wherein at least the base includes a plurality of inflated cells therein, at least two of said cells provided to be interconnected to allow the passage of gas between the cells when inflated.

In one embodiment the back rest is formed of a first rear layer and a second front layer with the majority of said first and second layers being held in a spaced apart configuration.

In whichever format, the structure provides the benefits of being lightweight, does not degrade in terms of performance over time. Can be provided in a waterproof form, does not generate dust or debris due to degradation, parts of, or entire structures can be replaced relatively easily, the structure can be recyclable and the materials used can be non-toxic.

In a further aspect of the invention there is provided a method of forming structure comprising a number of cells, at least two of which are interconnected by one or more ports to allow the passage of fluid therebetween when the structure is formed, said method comprising the steps of analysing the use to which the structure is to be put, identifying an area or areas of the structure at which impact is most likely to occur, locating a first cell at said area or areas of predicted greatest impact, and wherein substantially enclosing the said first cell to the side walls therefore by locating one or more further cells therewith and providing one or more ports to allow the controlled passage of fluid between the said first cell and the said further cell or cells.

Typically the said further cell or cells are provided as a first surrounding phase and then one or more further surrounding phases of cells are provided.

Specific embodiments of the invention are now described with reference to the accompanying drawings wherein;

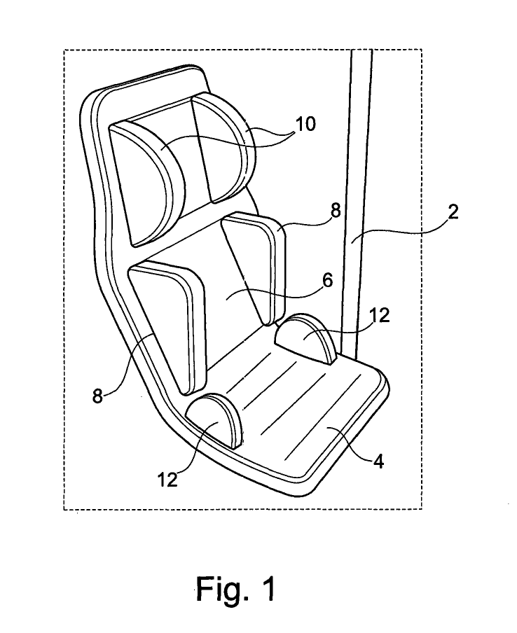

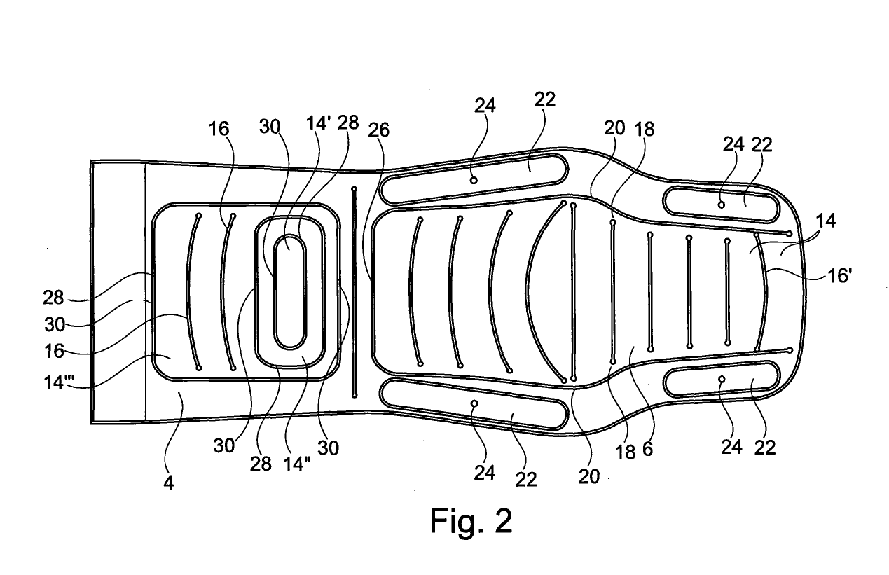

FIG. 1 illustrates a perspective view of the body of a structure in the form of an inflatable seat in accordance with one embodiment of the invention;

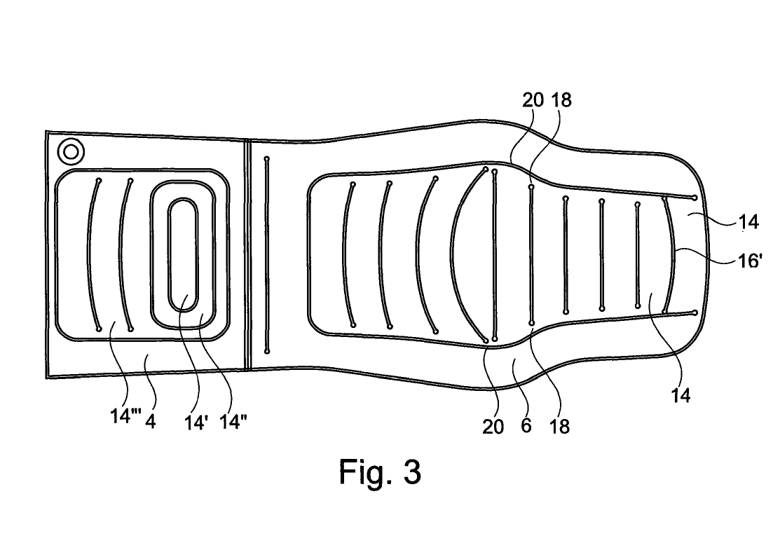

FIG. 2 illustrates a plan view of the front of the body of the structure in accordance with one embodiment of the invention;

FIG. 3 illustrates a plan view of the rear of the body of the inflatable seat in accordance with one embodiment of the invention;

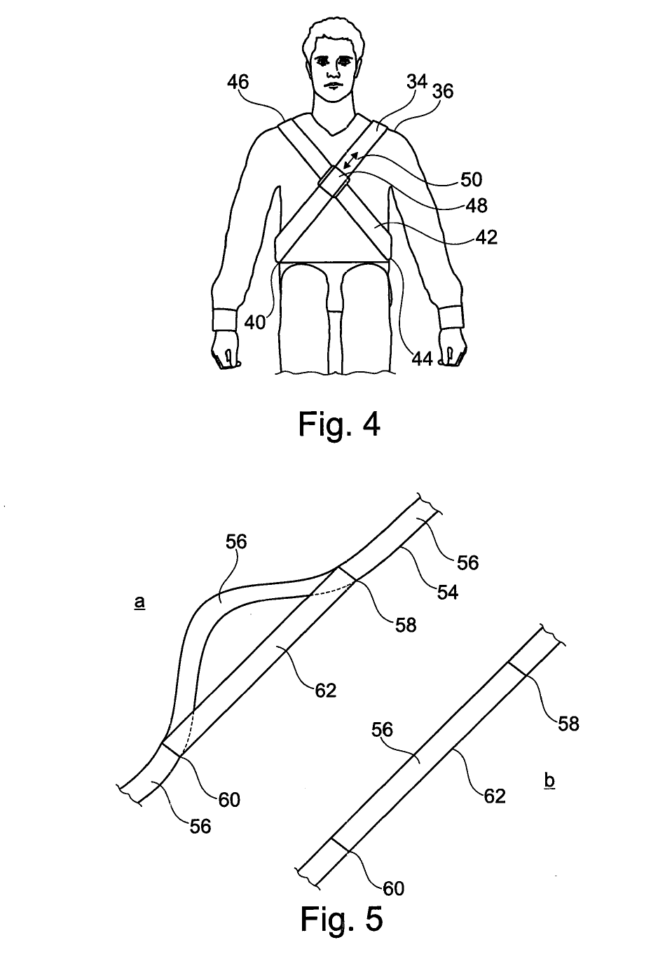

FIG. 4 illustrates a belt restraint system in accordance with one embodiment of the invention;

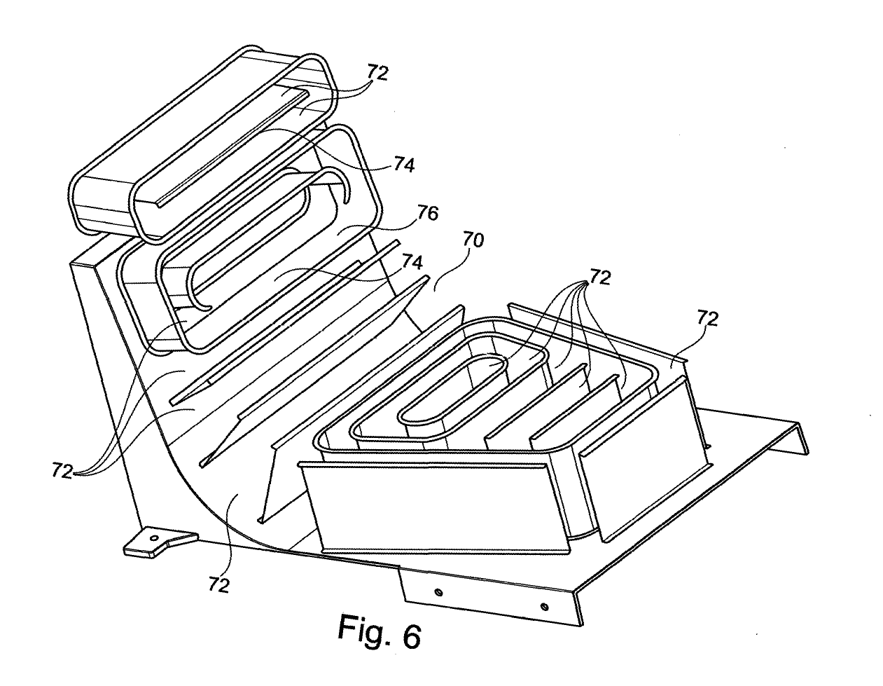

FIG. 5 illustrates a belt restraint system according to a further embodiment of the invention;

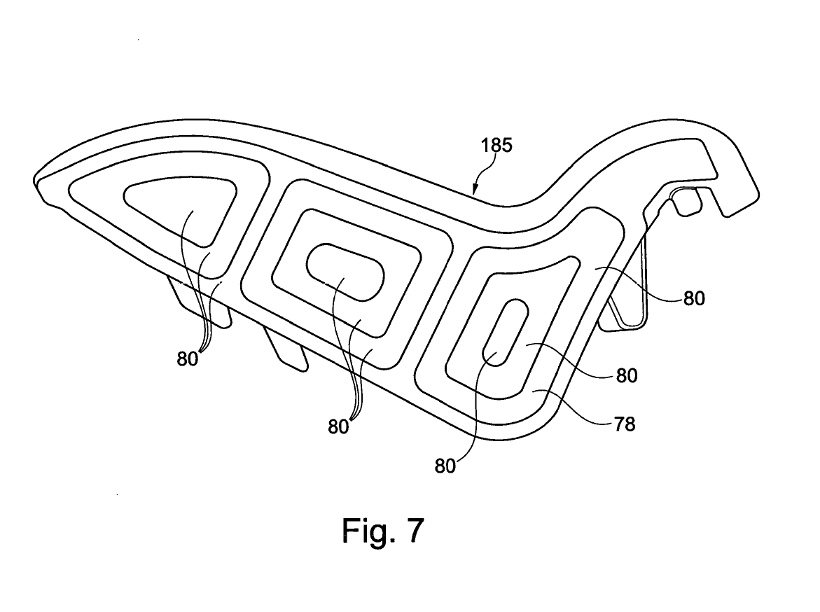

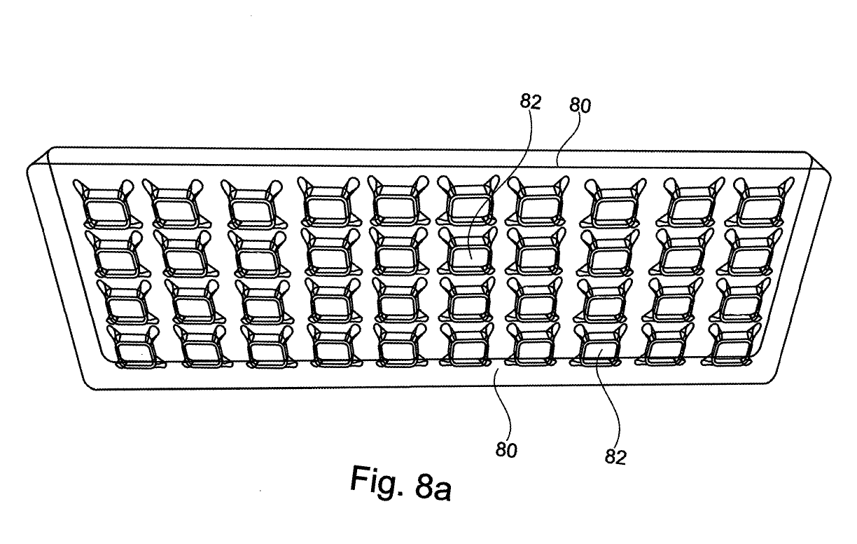

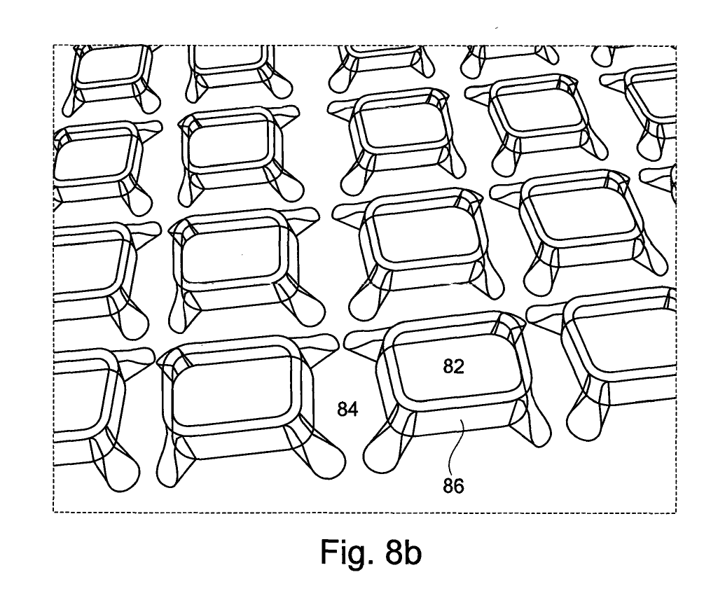

FIGS. 6 and 7 illustrate a further arrangement for a structure in accordance with one embodiment of the invention;

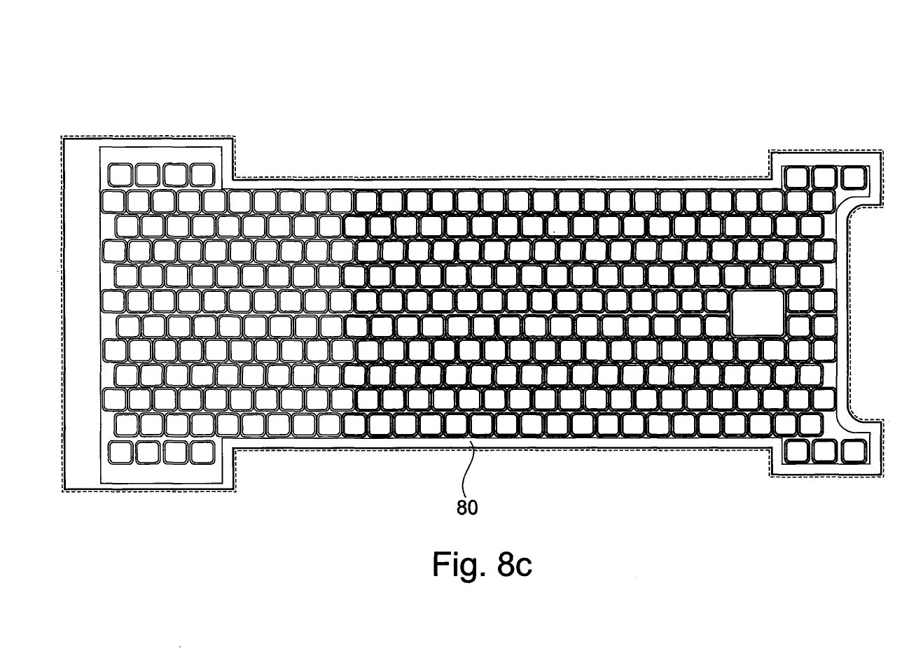

FIGS. 8a-c illustrate a structure in accordance with a further embodiment of the invention;

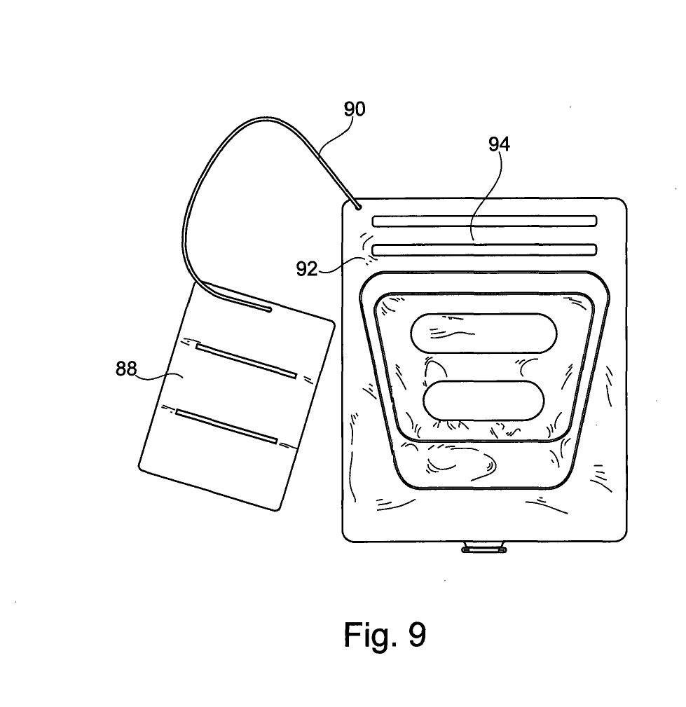

FIG. 9 illustrates a further embodiment of the invention;

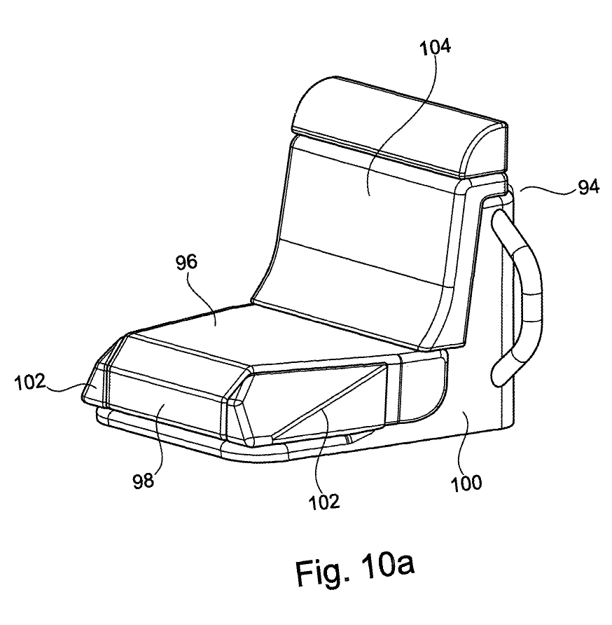

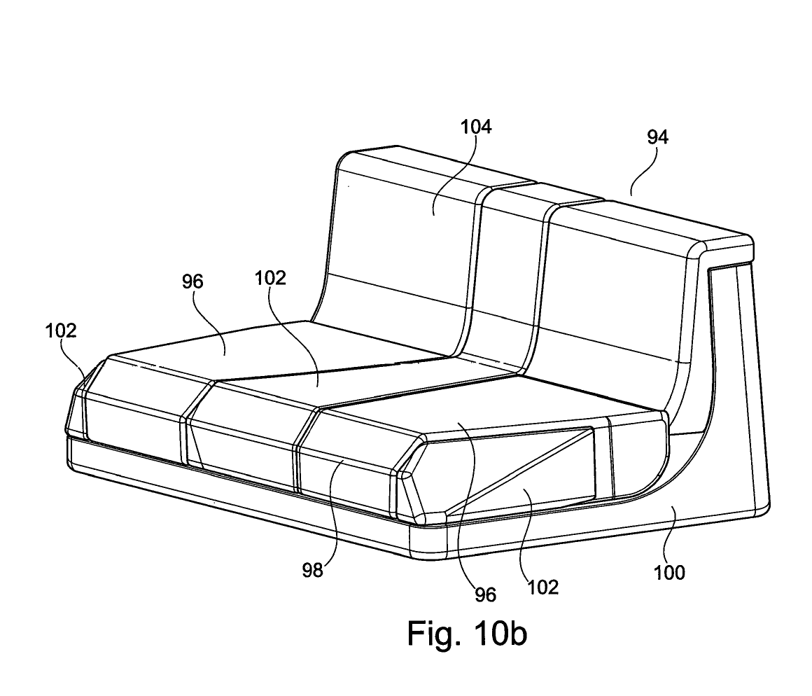

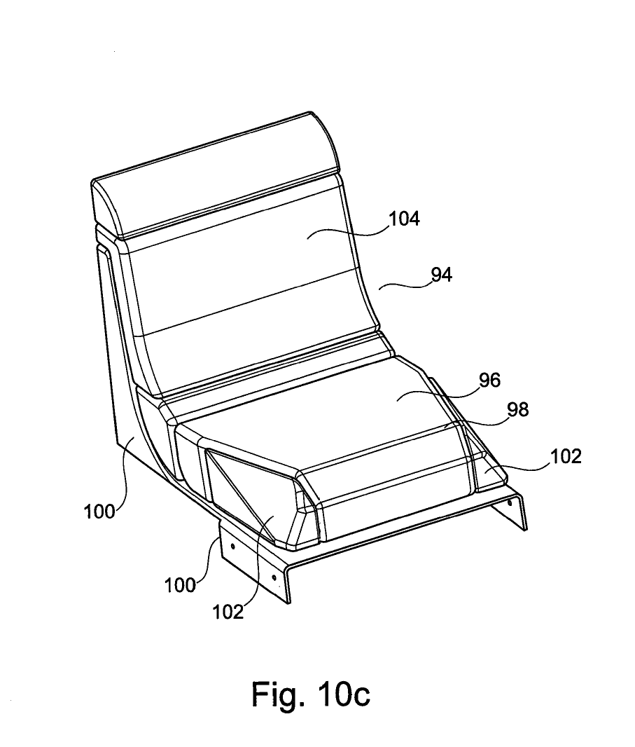

FIGS. 10a-c illustrate a further embodiment of the invention with the structure in the form of a seat;

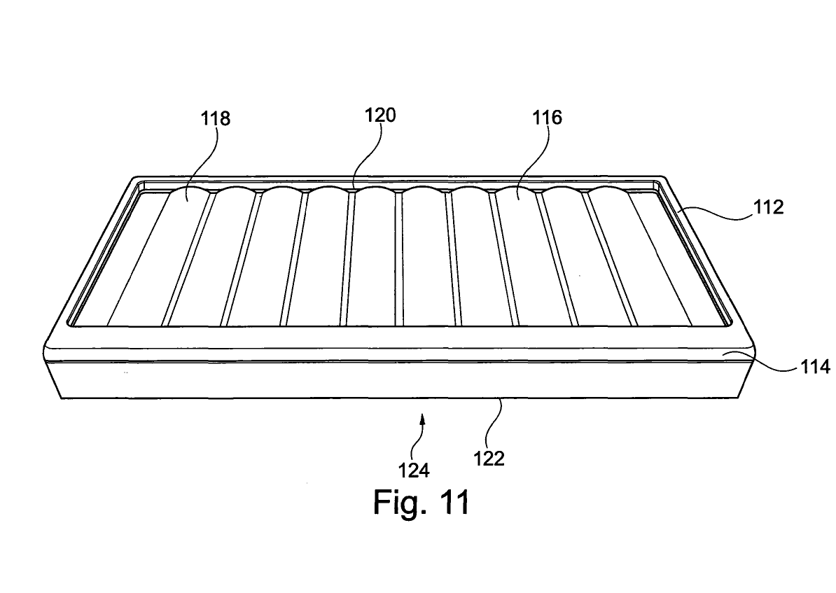

FIG. 11 illustrates a perspective view of a structure in accordance with one embodiment of the invention;

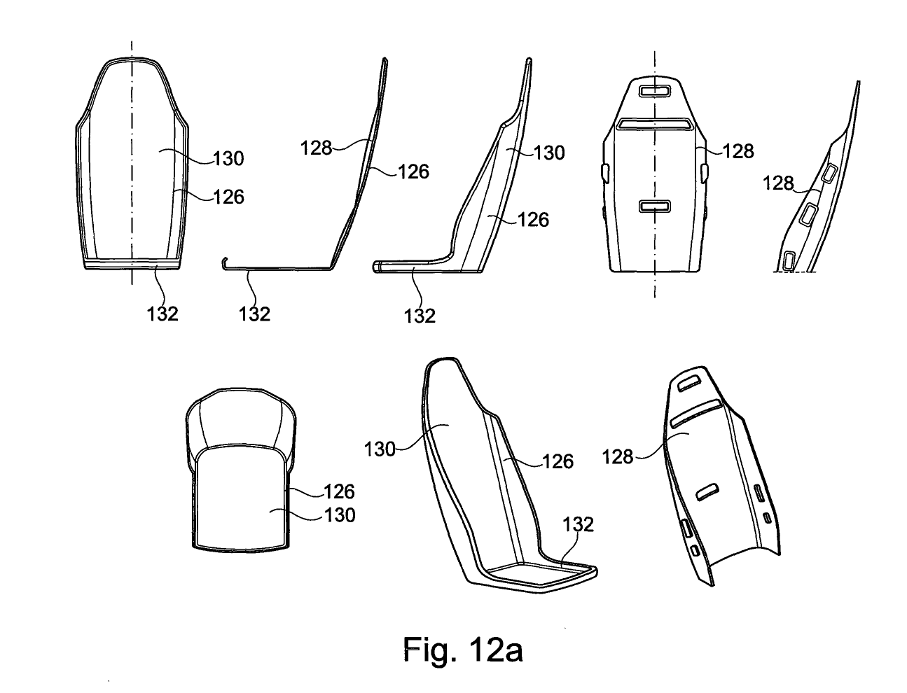

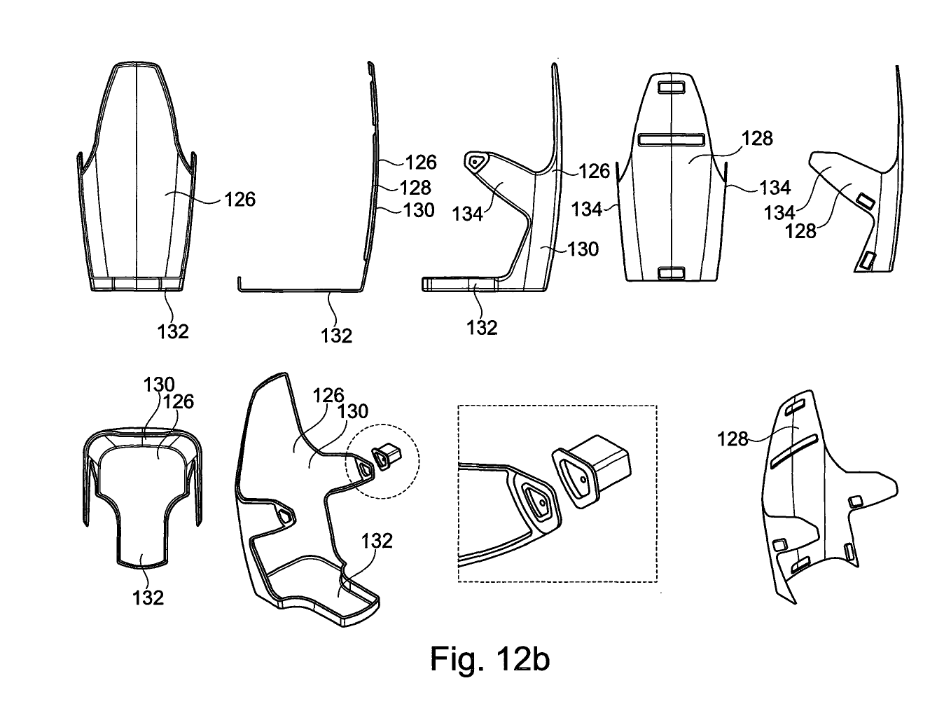

FIGS. 12a and b illustrate chair structures in accordance with a second embodiment of the invention; and

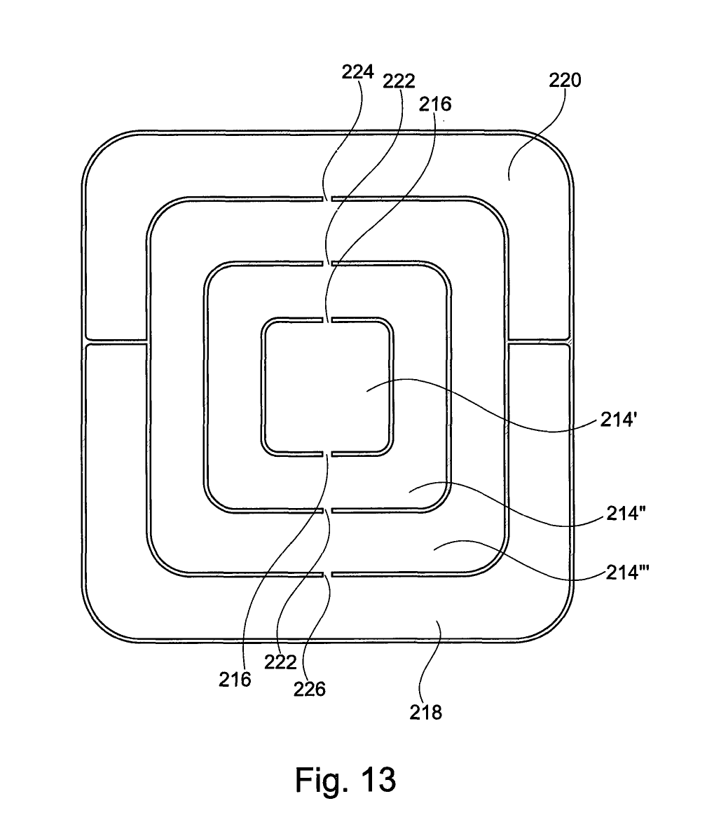

FIG. 13 illustrates a further embodiment of a structure in accordance with the invention in plane with a cross section through the sidewalls of the cells of the structure.

Referring firstly to FIG. 1 there is illustrated a view of the inflated body of a structure in accordance with the invention in the form of an inflatable seat in accordance with one embodiment of the invention. The body can be enclosed within a flexible sheet material envelope (not shown) which would form the external surface of the seat.

The body 2 comprises a base 4, back 6, side supports 8,10 and seat belt locators 12. In accordance with the invention the base and back 4,6 are provided with a number of cells 14 and the cells are interconnected by one or more ports in the walls of the structure which allow the passage of air therebetween in a manner which ensures that the structure of the seat is maintained as shown when the same is being sat on and/or is the subject of sudden impact.

FIGS. 2 and 3 illustrate the arrangement of the cells within the base and back portions of the body. It can be seen that in the back portion, cells 14 are defined by the walls or struts 16 which are positioned across the portion and air can pass between the cells through the ports 18 between the struts 16 and the side struts 20 with the exception of strut 16′ which is connected to the side struts 20 and therefore forms an enclosed compartment for the back portion and into which air can pass via port 26 at least. In the side supports 8, 10, there are provided cells 22 which are provided in communication with the remainder of the body by ports 24. Similarly, the back 6 is provided in airflow communication with the base via port 26.

The base is provided in accordance with this embodiment of the invention with a series of cells 14. The cell arrangement is shown in a preferred arrangement and the cell 14′ is wholly surrounded by cell 14″ which, in turn, is surrounded by cell 14″′ which includes further separating struts 16. The side walls 28 of the cells 14′, 14″, 14″′ are each provided with ports 30 which are selectively dimensioned and located so as to control the airflow between respective cells upon sudden impact and/or the application of pressure to specific cells. In this arrangement it will be found that the air flow from cell 14′ into cell 14″ is slowed by the restricted size and the number of ports which, in turn, means that the air pressure in the cell 14′ is maintained upon sudden impact. The cell is also located at the position on the base which receives the greater pressure from a person sitting on the base.

The same concept of cell structure as described above and in accordance with the invention is illustrated in FIG. 13 where there are provided a plurality of cells 214. The cells include a first cell 214′ which is located at a location on the structure at which it is known or predicted will be most likely to have an impact applied thereto, which could be due to the external environment, or the movement and contact of a person with the structure when the structure is in use. The first cell is connected to a further cell 214″ via one or more ports 216 and which allow the movement of air into and from a surrounding cell 214″. The surrounding cell is a first phase of surrounding cells, with cell 214″′ forming the next phase and the cells 218,220, in combination forming the next and last phase. Ports 222, connect the cell 214″ with cell 214″′ and the port 224 connects the cell 214″′ with the cell 220 and the port 226 connects the cell 214″′ with the cell 218.

In the arrangement shown, the ports are dimensioned such that there is a greater passage area between the cell 214′ and 214″ than there is between 214″ and 214″′ and again with respect to the passage area of the ports 224 and 226 which are again smaller than the ports 222. This means that there is a greater possibility of fluid flow from the first cell to the cell 214″ than there is in the successive phases of surrounding cells, in this embodiment. However, this configuration may be selected for specific purposes and design requirements and therefore the configuration of the ports may be reversed such that the passage area increases a between the phases of cells outwardly or is the same between each phase. The particular dimensions used are therefore dependent upon the particular dimensions of the cells, the particular use to which the structure is to be put, pressure of the fluid in the cells and/or the predicted size of impact which is predicted to be experienced.

It should also be appreciated that this form of cell configuration can be repeated within the same structure at different locations to suit the predicted high impact areas of the structure, if more than one is identified.

It should also be noted that the size of the ports 30 is smaller than the larger port 26 connecting the base and back parts of the body.

FIG. 3 also shows in this embodiment the use of a single inflation valve 32 to allow inflation and deflation of the seat.

Turning now to FIG. 4, there is illustrated a belt restraint system in accordance with the invention which comprises a first belt 34 which passes from the shoulder 36 of the person 38 to their hip 40 in a conventional manner. In accordance with the invention there is provided a second belt 42 which extends from a secured position at the hip 44 to the person's shoulder 46 at which is secured to the rear of the seat or object on which the seat is located. Attachment means 48 are provided at the crossover location of the two belts and the attachment means allow the sliding movement of the belts as indicated by arrow 50. Typically the second belt 42 is provided with a secured position at the hip 44 via a vehicle's three point first belt 34 assembly at the belt anchor, i.e. horizontally opposite to the release buckle for first belt 34.

FIG. 5 illustrates a further embodiment of the invention in which there is provided a portion of a safety belt which has, at a first end, means to secure the same (not shown) and, at the opposing end, releasable means to secure the belt in position for use. The portion 54 of the belt which is shown is formed of a first material 56 and at first and second locations 58, 60 a second material 62 is attached. The FIG. 5a shows the belt in a relaxed state and illustrates how the second material 62 is of a length in this state which is less than that of the first material 56 between the locations 58, 60. However, when force is exerted on the belt, as shown in FIG. 5b, the elasticity of the second material 62 means that the same extends in length so as to approach the length of the first material portion 62 between locations 58, 60 and which is relatively non elastic.

The structure described herein can be provided, in whichever embodiment, as independent units so as to form, or form part of, a deck, wall or ceiling, or as part of another structure, such as part of a seat frame or as part of the structure of the article into which the structure is to be installed, such as a vehicle or maritime craft.

FIGS. 6 and 7 illustrate further embodiments of the invention. In this case, a seat structure 70 is shown in FIG. 6 without the top face shown and this illustrates the manner in which a plurality of cells 72 are formed of different dimensions and sizes in order to be used at the appropriate location on the seat with regard to the specific use of the same. Furthermore, as required, ports 74 are located in the side walls 76 which define the cells to allow the controlled movement of the air between the adjacent cells 72. FIG. 7 illustrates a side bolster 78 which can selectively or permanently be attached to a seat structure 70 of the type shown in FIG. 6 and again the bolster is formed from a plurality of cells 80 defined therein. It should be appreciated that certain groups of cells may be interconnected to form separate units which, in conjunction with other units, form the structure. In this arrangement each of the units may be self contained in terms of the fluid supplied thereto and the fluid is only capable of flowing between the cells in that unit.

FIGS. 8a-c illustrate a further embodiment of a structure in accordance with the invention. In this case the structure relates to a base or deck 82 which is formed with a plurality of cells formed therein each connected with larger cell 84 via ports 86.

FIG. 9 illustrates a further embodiment of the invention which shows the provision of a further cell 88 connected via pipe 90 to a structure 92 in accordance with the invention. In this case the structure is formed of a plurality of cells as in the other embodiments and in this case cell 94′ is connected via pipe 90 to the further cell 88 to allow the transfer of fluid in a controlled manner between the cells and to effectively allow the structure 92 to breathe and hence provide the means for the pressure of air in the structure 92 to adjust in response to the use and/or impact thereof.

FIGS. 10a-c illustrate a further embodiment of the invention in which there is provided a seat 94 which is formed in a composite manner with the seat comprising an inflatable structure 96 which forms a portion of the base 98 of the seat. The seat is provided with a frame 100 which is typically formed of a relatively rigid material and which supports the structure 96 in position. In addition the remainder of the base 98 is formed by deformable portions 102 which may be of foam, or another suitable material and, in addition the back portions 104 may also be formed of foam or another suitable material such that it is the relatively high impact part of the base which is formed by an inflatable structure in accordance with the invention.

Referring now to FIG. 11 there is illustrated a structure 112 in accordance with a further embodiment of the invention. The structure includes a frame 114 which is relatively rigid in form. The frame defines an aperture which receives and retains an inflatable assembly 116. The assembly 116 includes a plurality of side by said parallel cells 118, each of which has a cavity for receiving an inflating gas therein so as to bring the assembly to an inflated condition. When inflated the assembly may be permanently retained in that condition or may be capable of being deflated and reinflated repeatedly.

The cells 118 are provided so as to be interconnected in terms of allowing the flow of gas between the cells, when inflated. This is typically achieved by providing one or more apertures in the common side walls of adjacent cells 118. The number and size of the apertures is dependent upon the requirements and constraints of movement of the fluid between the cells in terms of the particular use of the structure and the required extent of mitigation of the effect of an impact on the structure. In this case the structure is provided as a means for mitigating the effect of an impact such as an explosive blast. The top face 120 of the structure is provided to receive a person's feet thereon, such as when the person is sitting in a seat in a road or sea vehicle, with the structure, for example, being provided as part of the floor of the vehicle. The opposing face 122 of the stricture is therefore facing towards the location from which the impact of the blast is expected to be received in the direction of arrow 124. Thus the impact of the blast on underside 122 of the structure is mitigated as it passes through the assembly 116 and the fluid within the cells of the assembly moves between the cells so as to absorb the effect of the impact on the person's feet, and the remainder of the person.

FIGS. 12a and b illustrate two embodiments of a chair formed in accordance with the invention. The chair in both embodiments, includes an outer layer 126 and an inner layer 128. Typically the outer layer has a backrest portion 130 and a base portion 132. The inner layer forms a backrest portion. In FIG. 12b the outer and inner layers also include arm rest portions 134. Spacing portions 136 are provided which allow the inner and outer layers to be spaced apart at the backrest portion as is illustrated in the cross sectional view of FIGS. 12a and b and may be attached together using suitable fastening means such as hook and loop fastening. Padding may be incorporated into the seat backrest as appropriate.

The base portion 132 of the outer layer is provided to receive a series of an inflatable cell assembly (not shown) in which at least two interconnected inflatable cells are provided and which allow the transfer of fluid between the cells in the similar manner to that previously described with regard to the assembly of FIG. 11 which may be provided in a preinflated condition and then retained in that condition during subsequent use.

The structures in accordance with this application provide many advantages, one being, with regard to propelled vehicles and, as fuel efficiency becomes more of an issue in vehicle design, the structure is the perfect match for vehicle manufacturers looking to have a very high performing seat, whilst being able to significantly reduce the weight of the seat and improve fuel economy. This feature is attractive for the manufacturers of AEV's (Alternative Energy Vehicles), small cars, hybrids and aircraft where weight constraints are paramount.

As previously described the structure offers a unique way of maximising impact absorbency, by absorbing the force of moving mass, and slowing it down in a controlled manner. This principal is seen in some very expensive energy absorbent foam products which are soft in normal circumstances and become firm under sudden impact, but are very expensive.

The structures can also be seen as a “short stroke suspension cushion” and so seat manufacturers who are constrained by space in the cab or cockpit of the vehicle have a solution to occupant safety at a greatly reduced cost to short stroke suspension seat systems.

Road vibration over time causes driver fatigue, so after a long journey they feel tired. The structure of the invention reduces road and occupational vibration and, due to the seats air filled qualities, improves pulmonary circulation and driver comfort by distributing the weight of the occupant much more efficiently.

In one embodiment the structures are made from polyurethane materials. Polyurethanes are better performing than older plastics in everyway. PU's are stronger, more durable, more resistant to heat, cold, UV, and chemicals and are not gas permeable, so will not loose air over time.

Over time, foam seats degrade, due to prolonged use. This degradation of the foam reduces the beneficial properties of the foam, commonly loosing its impact absorbency and comfort. The structure of the invention will not degrade as the basic element is air.

Recent legislation on whole body vibration have now limited the exposure of vibration that certain vehicle operators are legally allowed to experience in a working day. Vehicle most likely to experience dangerous levels of vibration are fitted with suspension seating. But vibration will still pass through the chassis of the vehicle, through the floor pan and up through the suspension system through the seat frame to the occupant. The structure of the invention is compliments suspension seating, as it will mitigate any remnance of vibration so alleviating any restrictions on the length of time an, industrial vehicle operator may stay in a vehicle in a working day.

Because the structures can be shipped, transported and stored deflated, a manufacturer can transport many times the amount of structure as compared to traditional foam seats in the same cube, for the same cost. This equates to a significant reduction in storage and logistic costs. Another benefit is that the seats can be deflated when not in use, allowing the seats to be folded flat to allow for greater space in for example, a car if it becomes necessary to fold the seats away.

Other potential users include military blast mitigation seating and/or marine shock impact and vibration mitigation seating.

With the adoption of the structure, seat designers now have more flexible and options to design into their seats. Features now available with the structure offer a range of benefits that have not been available with traditional foam seating. The same can be said about the weight of current seats that may force vehicle manufacturers to compromise on features and benefits over the weight of the seat.

The light weight of the structure of the invention has the advantage of allowing safety/comfort and other improvements to be obtained while, at the same time, allowing the weight of the overall structure and apparatus to which the same is fitted, to be reduced.

Advancements in vehicle technology like AEV's (Alternative Energy Vehicles) and rising fuel prices are putting designers and manufacturers under pressure to come up with design solutions that perform well, but are lightweight so increasing fuel economy.

There is therefore provided a structure which allows the controlled movement of air or another gas through the seat cells and, by controlling the flow of the air or gas, so the comfort of use of the structure can be improved and, perhaps more importantly, the effects of sudden impact on the structure directly or indirectly can be reduced, thereby improving the safety of the same and the person sat in the same.

The structure in accordance with the invention therefore provides the ability, when the same is under load, to optimise energy absorption and provide adaptive pressure control for comfort. This avoids the sudden movement of air to one location in the structure upon an impact which, without the configuration herein defined would occur. The invention therefore provides control of the manner in which the structure reacts to and absorbs a person sitting on the structure and when the structure is under load and avoids the structure acting in the manner of a trampoline by avoiding the sudden movement of the fluid from one part of the structure to another.

1. A fluid filled structure, said structure having a body with a plurality of cells in which a fluid is received and wherein at least two of said cells are interconnected by at least one choke port to allow the passage of fluid between said cells in order to allow the controlled transfer of the fluid between the cells once the structure is filled with the desired quantity of the fluid for use and during use of the structure wherein a first cell is provided with a top wall and a base wall spaced apart by side walls, said side walls attached to, or common with, side walls of one or more adjacent cells such that the said first cell is substantially surrounded by one or more cells and provided in fluid communication with the cell or cells adjacent the side walls thereof via said one or more ports in order to allow the passage of fluid between the respective cells.

2. (canceled)

3. (canceled)

4. (canceled)

5. A structure according to claim 1 wherein there are provided one or a series of cells in successive phases outwardly from said first cell, said phase in interconnected to at least one of the first cell or a further phase adjacent thereto via said ports and the passage area of the port or ports in combination which connect the first cell to the surrounding cell or cells phase and through which fluid can pass is different to the passage area of the port, or ports in combination, which connect the said surrounding cell or cells phase to the next phase of cell or cells.

6. (canceled)

7. (canceled)

8. A structure according to claim 1 wherein when the structure is in a dormant state and inflated no, or limited, movement of fluid between cells occurs and movement of fluid occurs upon a sudden impact and/or movement of a person in contact with the apparatus with the movement of the fluid regulated by the at least one port which interconnects the cells.

9. A structure according to claim 1 wherein the at least one port is of a dimension and/or is controlled such as to restrict the passage of air so as to substantially maintain the structure in a desired form and/or maintain the air pressure within a specific cell or cells when the pressure on that cell is increased so as to decrease the speed of change of the structure and/or the size of the cell for at least a period of time following the occurrence of an impact and/or movement with respect to the structure.

10. A structure according to claim 1 wherein the interconnected cells which are closest to a predetermined portion of the structure are interconnected by one or more ports which are of a dimension so as to allow a greater flow of air therethrough in comparison to the port or ports which interconnect other cells of the structure which are further removed from the predetermined portion.

11. (canceled)

12. (canceled)

13. (canceled)

14. A structure according to claim 1 wherein the structure is formed by a plurality of cells which are interconnected and adjacent cells are interconnected by at least one port and arranged in series.

15. (canceled)

16. (canceled)

17. A structure according to claim 1 wherein the structure includes at least one pump for the movement of fluid into the structure and one or more regulators to allow the controlled movement of the fluid.

18. (canceled)

19. (canceled)

20. (canceled)

21. A structure according to claim 1 wherein the cells are provided as part of a body which is secured to a relatively rigid support which forms a rear support shell to the structure.

22. (canceled)

23. (canceled)

24. A structure according to claim 1 wherein the structure includes an inflatable cell or vent bag which is connected to, but separable from, the structure, said inflatable cell or vent bag acting as a reservoir for a quantity of fluid and connected to allow the transfer of fluid between the inflatable cell or vent bag and at least one of the cells of the structure.

25. A structure according to claim 24 wherein the inflatable cell or vent bag allows a quantity of fluid to be available to be moved between the one or more inflatable cells of the structure and the inflatable cell or vent bag upon impact.

26. A structure according to claim 1 wherein the structure is used to form an impact resistant surface in the form of any or any combination of a wall, floor, deck and/or ceiling of a building or vehicle, or as a layer for the same or for an item of clothing and/or used as, or part of, a seat in any or any combination of vehicles, marine craft, aircraft, military vehicles, use by children with special needs, decks or floors.

27. (canceled)

28. (canceled)

29. (canceled)

30. A structure which is provided as a means of mitigating the effect of an impact or blast on a person in contact with, or in the vicinity of the said structure, and wherein said structure includes a plurality of cells, each of said cells provided to be moved and/or retained in an inflated condition by a gas contained therein and wherein at least two of the said cells are interconnected such that once inflated, the fluid can pass between the said interconnected cells in a regulated and controlled manner wherein the regulation is achieved by the provision of one or more ports or passages which interconnect the said cells so as to allow the passage of gas between the cells but to restrain the flow of transfer of the gas through the ports or passages.

31. (canceled)

32. A structure according to claim 30 wherein the structure is provided with a first surface onto which a person is able to place part of their anatomy and the opposing surface of the structure is provided to face towards the most likely source of the impact such that the structure is positioned intermediate the person's anatomy and the source of impact.

33. (canceled)

34. A structure according to claim 34 wherein the structure is incorporated to form the base of a seat, said seat also having a back rest formed of a first rear layer and a second front layer with the majority of said first and second layers being held in a spaced apart configuration.

35. A method of forming structure comprising a number of cells, at least two of which are interconnected by one or more ports to allow the passage of fluid therebetween when the structure is formed, said method comprising the steps of analysing the use to which the structure is to be put, identifying an area or areas of the structure at which impact is most likely to occur, locating a first cell at said area or areas of predicted greatest impact, and wherein substantially enclosing the said first cell to the side walls therefore by locating one or more further cells therewith and providing one or more ports to allow the controlled passage of fluid between the said first cell and the said further cell or cells.

36. A method according to claim 35 wherein the said further cell or cells are provided as a first surrounding phase and then one or more further surrounding phases of cells are provided.
